(19) United States
(12) Patent Application Publication
(10) Pub. No.: US 2017/0222682 A1
(43) Pub. Date: Aug. 3, 2017

(54) CELL PHONE SCREEN PROTECTOR PASTING DEVICE AND CELL PHONE SCREEN PROTECTOR

(71) Applicant: WING TAK LEE SILICONE RUBBER TECHNOLOGY (SHENZHEN) CO., LTD, Shenzhen (CN)

(72) Inventor: Tak Nam Liu, Shenzhen (CN)

(21) Appl. No.: 15/067,158

(22) Filed: Mar. 10, 2016

(30) Foreign Application Priority Data
Jan. 30, 2016 (CN) 201610067943.5

(51) Int. Cl. H04B 1/3888

(52) U.S. Cl. CPC H04B 1/3888

(57) ABSTRACT

The present invention provides a cell phone screen protector pasting device and a cell phone screen protector. A back surface of the cell phone screen protector pasting device is provided with a hollow frame mating with a dimension of a cell phone outer frame. An upper platform and a lower platform respectively extend out of the hollow frame along a Y-axis direction, wherein a front surface of the upper platform is provided with an upper concave plane, and a front surface of the lower platform is provided with a lower concave plane. The upper concave plane is fixedly provided with at least two upper retainers which extend out of the upper concave plane in a height direction, and the lower concave plane is fixedly provided with at least two lower retainers which extend out of the lower concave plane in a height direction.

### CROSS-REFERENCE TO RELATED APPLICATIONS

The present application claims the benefit of Chinese Patent Application No. 201610067943.5 filed on Jan. 30, 2016, the contents of which are hereby incorporated by reference.

### TECHNICAL FIELD

The present invention relates to the field of cell phone accessories, and in particular, relates to a cell phone screen protector pasting device and a cell phone screen protector.

### BACKGROUND

Cell phones are commonly used electronic products in people's live. The current cell phones, especially emergence of Apple iPhone series smart phones, are greatly changing people's life style. With drastic development of the cell phones, the cell phones are being equipped with larger and larger screen, and are becoming thinner and thinner. In this case, the screens of the cell phones is fragile, especially the screens of the iPhone 6 Plus series cell phones. To prevent the screens from being broken and scratched, screen protectors are generally pasted on the screens, which not only protect the screens but also do not affect the appearance and use of the cell phones. Due to wide application of the cell phone screen protectors, substantially all the smart phones, especially large-screen cell phones are pasted with screen protectors.

During implementation of the technical solution in the related art, it is found that the related art has the following technical problem:

Since the cell phone screen protectors are very thin and they are to be pasted on the screens of the cell phones, the screen protectors need to be transparent and to be tightly laminated to the screens to not affect normal use of the cell phones. Bubbles and inaccurate dimensions are the biggest problems during pasting of the screen protectors. To solve these problems, conventionally users would make their screen protectors be pasted on the screens by skilled persons. Since the pasting of the screen protectors is more and more costly, pasting of a very cheap screen protector generally needs a labor cost of 10 yuan or more, whereas non-skilled persons would not ensure the accuracy of the dimensions and no generation of bubbles. Therefore, the conventionally screen protector pasting is costly, and in addition the accuracy of the dimensions and no bubbles may not be ensured.

### SUMMARY

Embodiments of the present invention are intended to provide a cell phone screen protector pasting device, to solve the problems that the screen protector pasting cost is high, the dimension is inaccurate and there are bubbles under the pasted screen protector.

A first aspect of the present invention provides a cell phone screen protector pasting device, wherein a back surface of the cell phone screen protector pasting device is provided with a hollow frame mating with a dimension of a cell phone outer frame; wherein

an upper platform and a lower platform respectively extend out of the hollow frame along a Y-axis direction, a front surface of the upper platform being provided with an upper concave plane, a front surface of the lower platform being provided with a lower concave plane; and

the upper concave plane is fixedly provided with at least two upper retainers which extend out of the upper concave plane in a height direction, and the lower concave plane is fixedly provided with at least two lower retainers which extend out of the lower concave plane in a height direction.

Optionally, a left platform and a right platform respectively extend out of the hollow frame along an X-axis direction, the left platform being fixedly provided with a left lug, the right platform being provided with a right lug; wherein one end of the left lug is aligned with a left inner side surface of the hollow frame and one end of the right lug is aligned with a right inner side surface of the hollow frame.

Optionally, the left lug and the right lug are symmetrically arranged.

Optionally, one end of the upper concave plane is provided with an opening end.

Optionally, the upper concave plane is provided with a mark.

A second aspect of the present invention provides a cell phone screen protector for use in the cell phone screen protector pasting device according to the first aspect, wherein the cell phone screen protector comprises No. 1 film 201, No. 2 film 201, and No. 3 film;

wherein an upper protrusion and a lower protrusion respectively extend out of the No. 1 film along two ends of a Y-axis, the upper protrusion being provided with at least two upper openings mating with upper retainers, the lower protrusion being provided with at least two lower openings mating with lower retainers; and a back surface of the No. 3 film is provided with a tear tag.

Optionally, the upper protrusion is provided with a tear end mating with an opening end.

According to the embodiments of the present invention, the technical solution provided by the present invention has advantages of low screen protector pasting cost, accurate dimension and no bubble.

### BRIEF DESCRIPTION OF THE DRAWINGS

FIG. 1 is a rear view of a cell phone screen protector pasting device according to one embodiment of the present invention;

FIG. 2 is view illustrating use principle of a cell phone screen protector pasting device according to one embodiment of the present invention;

FIG. 3 is a structural view of a cell phone screen protector according to another embodiment of the present invention; and

FIG. 4 is a front view of a cell phone screen protector pasting device according to one embodiment of the present invention.

### DETAILED DESCRIPTION

To make the objective, technical solution, and advantages of the present invention more clear, the following section describes the technical solutions of the present invention in combination with the accompanying drawings and embodiments. It should be understood that the embodiments described here are only exemplary ones for illustrating the present invention, and are not intended to limit the present invention.

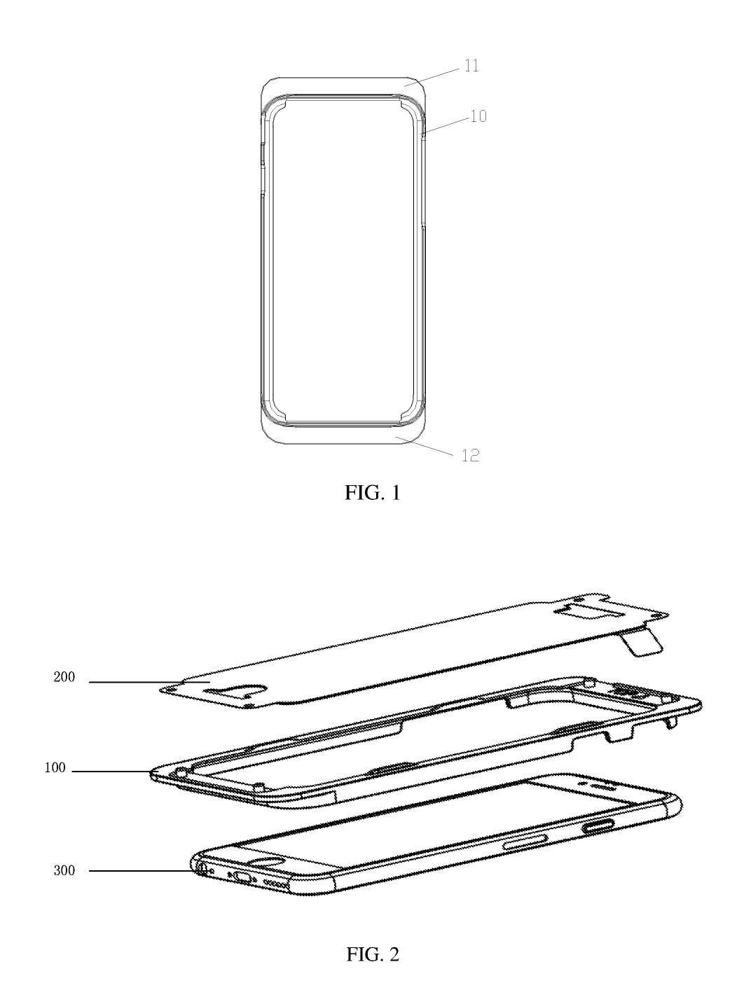

Referring to FIG. 1 and FIG. 4, FIG. 1 is a schematic structural view of a cell phone screen protector pasting device 100 according to an embodiment of the present invention. It should be noted that, in FIG. 1, design of a screen protector pasting device is illustrated by using an Apple iPhone 6S as an example, but the technical solution according to the embodiments of the present invention is not limited to application to Apple iPhone 6S series cell phones and is also applicable to other cell phones. For example, the technical solution according to the embodiments of the present invention may be applied to past screen protectors for Apple iPhone 6S Plus, iPhone 6, iPhone 6 Plus, Huawei Mate 7, Huawei Mate 6, Samsung, Oppo and the like cell phones. As illustrated in FIG. 1, in the cell phone screen protector pasting device:

A back surface of the cell phone screen protector pasting device 100 is provided with a hollow frame 10 mating with a dimension of a cell phone outer frame. An upper platform 11 and a lower platform 12 respectively extend out of the hollow frame 10 along a Y-axis direction, wherein a front surface of the upper platform 11 is provided with an upper concave plane 110 and a front surface of the lower platform 12 is provided with a lower concave plane 120. The upper concave plane 110 is fixedly provided with at least two upper retainers 111 which extend out of the upper concave plane 110 in a height direction, and the lower concave plane 120 is fixedly provided with at least two lower retainers 121 which extend out of the lower concave plane 120 in a height direction.

The working principles of the cell phone screen protector pasting device provided in an embodiment of the present invention are described with reference to FIG. 2. The working state of the cell phone screen protector pasting device is illustrated in FIG. 2. As illustrated in FIG. 2, the cell phone screen protector pasting device is represented by reference numeral 100 in FIG. 2. A cell phone screen protector 200 is placed over the cell phone screen protector pasting device 100, and a cell phone 300 is placed under the cell phone screen protector pasting device 100. During operation of the screen protector pasting device 100, the cell phone screen protector 200 is firstly fixed by using the upper retainers 111 and the lower retainers 121. The cell phone screen protector pasting device 100 is then turned over to cause the back surface of the screen protector pasting device 100 to face upwards. Afterwards, the No. 3 film of the cell phone screen protector 200 is torn off, and a screen face of the cell phone 300 is aligned with a hollow frame 10 mating with a dimension of a cell phone outer frame and the cell phone is placed still for a period of time. In this way, the cell phone would is well laminated to the No. 2 film of the cell phone screen protector 200 under the effect of gravity. The cell phone screen protector pasting device 100 and the cell phone are turned over simultaneously, and the No. 1 film of the cell phone screen protector 200 is torn off. Finally, the cell phone 300 is taken out. In this way, the No. 2 film applied to the screen of the cell phone is tightly laminated to the screen of the cell phone. Therefore, the cell phone screen protector according to the present invention has the advantages of simple mastery by any user, effective dimension location and reduction of bubbles. To be specific, since four retainers are arranged (including two upper retainers and two lower retainers), the location of the cell phone screen protector 200 is fixed. As such, the dimensions of the cell phone screen and the cell phone screen protector 200 may not change. Further due to the effect of gravity, the No. 2 film is well laminated to the cell phone screen. In this case, the bubbles are effectively reduced. Therefore, the cell phone screen protector has the advantages of reduction of bubbles and effective dimension location. In addition, the upper concave plane and the lower concave plane enable the cell phone screen protector 200 to be more closely laminated to the cell phone screen. Such configurations prevent bubbles under the pasted screen protector.

In an optional solution according to an embodiment of the present invention, a left platform 130 and a right platform 140 respectively extend out of the hollow frame 10 along an X-axis direction, the left platform 130 being fixedly provided with a left lug 131, the right platform 140 being provided with a right lug 141; wherein one end of the left lug 131 is aligned with a left inner side surface 101 of the hollow frame 10 and one end of the right lug 141 is aligned with a right inner side surface 102 of the hollow frame 10.

In a technical solution according to an embodiment of the present invention, a left platform and a right platform are arranged, and a lug is respectively on each of the left and right platform. As such, the location of the cell phone screen protector 200 is limited, thereby achieving a retaining effect. That is, the cell phone screen protector 200 may be retained between the left lug and the right lug. In this way, the cell phone screen protector may not be misplaced in the X-axis direction. In addition, alignment of the inner side surfaces of the hollow frame is to prevent impacts onto the lamination of the No. 2 film of the screen protector, which thus achieves a better retaining effect.

Optionally, the left lug 131 and the right lug 141 may be symmetrically arranged. The symmetric arrangement achieves a better retaining effect.

In another optional solution according to an embodiment of the present invention, one end of the upper concave plane 110 is provided with an opening end 1101.

In the technical solution according to an embodiment of the present invention, with the opening end arranged on the upper concave platform 110, a No. 1 film may be conveniently torn off from the cell phone screen protector 200 because with an arranged opening end, a tearing portion of the No. 1 film may be arranged at a corresponding position of the cell phone screen protector 200. In this way, the tearing portion may be disposed at the opening end 1101, and thus a user is capable of conveniently tearing the No. 1 film of the cell phone screen protector by using the tearing portion mating with an opening segment.

Optionally, in another technical solution according to an embodiment of the present invention, the upper concave plane 110 is provided with a mark. The mark may be specifically an arrow, an English letter, a Chinese character, a Japanese word, a German word or the like, which is not limited to the specific form of the mark. The mark is arranged mainly for the purpose of reminding the user of the direction of the cell phone screen protector. In this way, the user is capable of conveniently finding a corresponding cooperation direction between the cell phone screen protector and the cell phone screen protector pasting device.

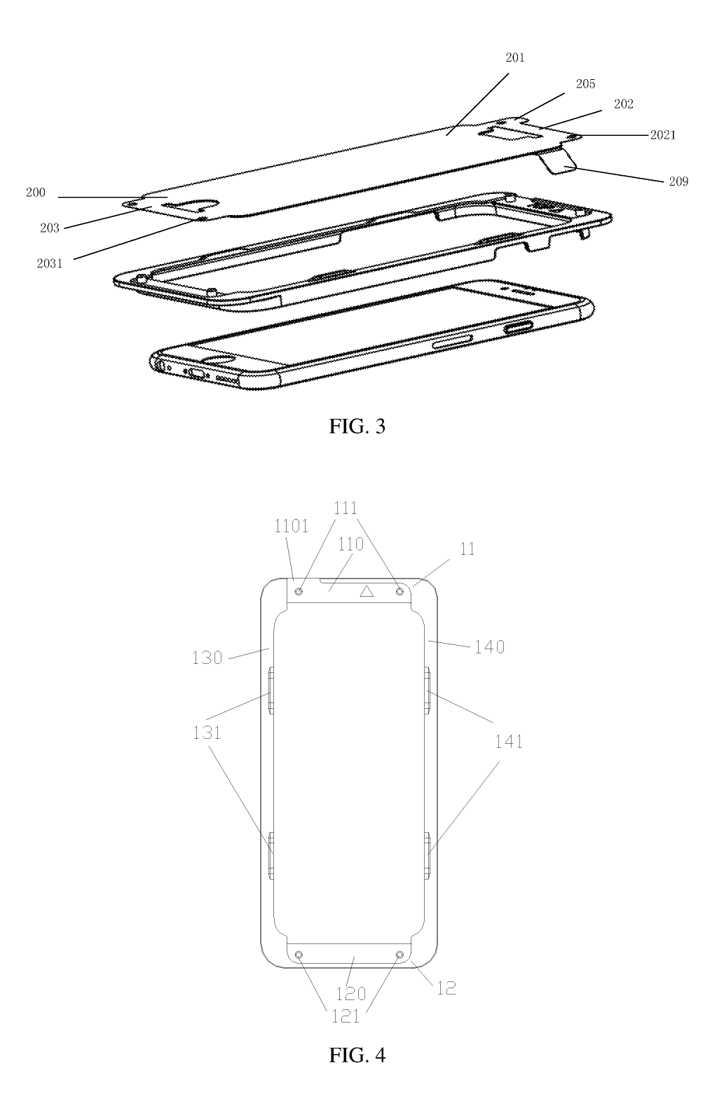

Referring to FIG. 3, FIG. 3 illustrates a cell phone screen protector 200 according to another embodiment of the present invention. The cell phone screen protector 200 may comprise No. 1 film 201, No. 2 film (which is sandwiched between the No. 1 film and No. 3 film and may not be obviously detected), and No. 3 film (not illustrated in FIG. 3). In the related art, the No. 1 film 201 is mainly opposite to the front surface of the No. 2 film (the front surface of the No. 2 film may also be referred to as a touch control surface, that is, a user implement touch control on the cell phone via the front surface of the No. 2 film). The No. 2 film may also be a protection film of the cell phone screen, which is a core layer of the cell phone screen protector. The No. 3 film may protect a back surface of the No. 2 film (the back surface of the No. 2 film is in direct contact with the cell phone screen). In the cell phone screen protector, as illustrated in FIG. 3, an upper protrusion 202 and a lower protrusion 203 respectively extend out of the No. 1 film 201 along two ends of a Y-axis, wherein the upper protrusion 202 is provided with at least two upper openings 2021 mating with the upper retainers 111, the lower protrusion 203 is provided with at least two lower openings 2031 mating with the lower retainers 112; and a back surface of the No. 3 film is provided with a tear tag 209.

The implementation principle of a technical solution according to another embodiment of the present invention is as follows: The at least two upper openings and the at least two lower openings of the cell phone screen protector 200 are sleeved onto the upper retainers and the lower retainers, the cell phone screen protector pasting device is turned over, the No. 3 film is torn off via the tear tag of the No. 3 film, the cell phone is placed still on the cell phone screen protector pasting device, afterwards the cell phone screen protector pasting device and the cell phone screen protector are turned over, and finally the No. 1 film of the cell phone screen protector is torn off to laminate the No. 2 film to the screen of the cell phone. Therefore, pasting of the cell phone screen protector is convenient.

Optionally, the upper protrusion 202 is further provided with a tear end 205 mating with an opening end. The No. 1 film may be simply torn off via the tear end 205, and then the No. 2 film is laminated to the screen of the cell phone.

Described above are merely preferred embodiments of the present invention, but are not intended to limit the present invention. Any modification, equivalent replacement, or improvement made without departing from the spirit and principle of the present invention should fall within the protection scope of the present invention.

What is claimed is:

1. A cell phone screen protector pasting device, wherein a back surface of the cell phone screen protector pasting device is provided with a hollow frame mating with a dimension of a cell phone outer frame; wherein
an upper platform and a lower platform respectively extend out of the hollow frame along a Y-axis direction, a front surface of the upper platform being provided with an upper concave plane, a front surface of the lower platform being provided with a lower concave plane; and
the upper concave plane is fixedly provided with at least two upper retainers which extend out of the upper concave plane in a height direction, and the lower concave plane is fixedly provided with at least two lower retainers which extend out of the lower concave plane in a height direction.

2. The cell phone screen protector pasting device according to claim 1, wherein a left platform and a right platform respectively extend out of the hollow frame along an X-axis direction, the left platform being fixedly provided with a left lug, the right platform being provided with a right lug;
wherein one end of the left lug is aligned with a left inner side surface of the hollow frame and one end of the right lug is aligned with a right inner side surface of the hollow frame.

3. The cell phone screen protector pasting device according to claim 2, wherein the left lug and the right lug are symmetrically arranged.

4. The cell phone screen protector pasting device according to claim 1, wherein one end of the upper concave plane is provided with an opening end.

5. The cell phone screen protector pasting device according to claim 1, wherein the upper concave plane is provided with a mark.

6. A cell phone screen protector used in the cell phone screen protector pasting device as defined in claim 1, wherein the cell screen protector comprises No. 1 film 201, No. 2 film 201, and No. 3 film; wherein
an upper protrusion and a lower protrusion respectively extend out of the No. 1 film along two ends of a Y-axis, the upper protrusion being provided with at least two upper openings mating with upper retainers, the lower protrusion being provided with at least two lower openings mating with lower retainers; and a back surface of the No. 3 film is provided with a tear tag.

7. The cell phone screen protector according to claim 6, wherein the upper protrusion is provided with a tear end mating with an opening end.
